(19) United States
(12) Patent Application Publication
(10) Pub. No.: US 2018/0134836 A1
(43) Pub. Date: May 17, 2018

(54) POLYURETHANE COVERINGS HAVING REDUCED WATER ABSORPTION AND USE THEREOF

(71) Applicant: Covestro Deutschland AG, Leverkusen (DE)

(72) Inventors: Birgit MEYER ZU BERSTENHORST, Leverkusen (DE); Uwe PFEUFFER, Leverkusen (DE); Heike NIEDERELZ, Leverkusen (DE); Hartmut NEFZGER, Pulheim (DE)

(21) Appl. No.: 15/570,214

(22) PCT Filed: Apr. 26, 2016
(86) PCT No.: PCT/EP2016/059275

§ 371 Date: Oct. 27, 2017

(30) Foreign Application Priority Data
Apr. 28, 2015 (EP) 15165377.1
Dec. 16, 2015 (EP) 15200574.0

(51) Int. Cl. C08G 18/32; C08G 18/38; C08G 18/40; C08G 18/44; C08G 18/48; C08G 18/66; C09D 175/06

(52) U.S. Cl. CPC C08G 18/3206; C08G 18/3814; C08G 18/4018; C09D 175/06; C08G 18/48; C08G 18/6637; C08G 18/44

(57) ABSTRACT

The invention relates to coverings made of polyurethane having reduced water absorption and the use thereof.

The invention relates to polyurethane outer shells having reduced water absorption and to the use thereof.

Polyurethanes have a general tendency to absorb water and in some cases to swell, which is highly disadvantageous in many applications.

Accordingly, it was an object of the present invention to provide outer shells based on polyurethane (PUR) systems that exhibit minimum water absorption.

This object was achieved through the use of alkylene oxide-CO₂ polyether carbonate polyols (PEC) as reactive component in the polyurethane system. The incorporation of PECs of this kind surprisingly led to a distinct reduction in the water absorption of the polyurethane systems thus modified compared to prior art polyurethane systems that are analogous but based on polyether polyols based on ethylene oxide and/or propylene oxide, on polyester polyols (PES) or on polycarbonate polyols.

By comparison with the conventional reactive polyurethane systems, the systems used in accordance with the invention are still notable in that, as a result of the use of PEC, they are more resource-conserving and hence more sustainable than conventional systems, since a portion of the polymer chains does not consist of fossil raw materials but of carbon dioxide, a greenhouse gas incorporated into the polymer chains.

Fields of use for the polyurethane outer shells of the invention include construction and the automotive industry.

An outer shell in this application means the partial or complete covering of a component with the reactive polyurethane system used in accordance with the invention, where the component may consist of any desired material. The outer shell may have various purposes and may be occasioned, for example, by demands such as edge protection, sealing, a moisture barrier, encapsulation of sensitive components (e.g. sensors), decoration and lamination. Outer shells can also serve as a connecting element between two or more components. Examples include: outer shell of sheets and slabs of any kind, for example of glass panes, of tiles, of laminates, for example of plywood boards, of particleboards, of coreboards and of metal plates. Other possibilities are the outer shell of cables, of solar modules and of sensors. Outer shells can also be used as sealing material, for example as sealing rings.

The invention provides outer shells composed of a polyurethane, wherein the polyurethane is obtainable from:
A) a polyol component consisting of
   A1) 5% to 90% by weight, preferably 10% to 80% by weight, more preferably 13% to 75% by weight, of at least one polyether carbonate polyol (PEC) having a number-average molecular weight (M) of 600 to 6000 Da (measured according to DIN 53240; December 1971 and calculated by the formula: M=56 100⋅functionality/OH number) and a number-average functionality of 2 to 3 and
   A2) 10% to 95% by weight, preferably 20% to 90% by weight, of at least one further polyol having a number-average molecular weight of 200 to 6500 Da (measured according to DIN 53240; December 1971 and calculated by the formula: M=56 100⋅functionality/OH number) from the group consisting of polyether polyols having a number-average functionality of 2 to 8, polyester polyols having a number-average functionality of 2 to 3 and polycarbonate polyols having a number-average functionality of 2 to 3 and
   A3) 2% to 20% by weight of aliphatic alkanediols each having number-average molecular weights of 62 to 500 Da (measured according to DIN 53240; December 1971 and calculated by the formula: M=56 100⋅functionality/OH number) and
   A4) 0% to 10% by weight of short-chain aliphatic polyamines and/or aliphatic amino alcohols having number-average molecular weights of 60 to 1200 Da (measured according to DIN 53240; December 1971 and calculated by the formula: M=56 100⋅functionality/OH number or NH number) and a functionality of 2,
   A5) catalysts and
   A6) optionally auxiliaries and/or additives
   where the sum total of A1), A2), A3), A4), A5) and A6) is 100% by weight, and
B) an isocyanate component consisting of
   B1) at least one isocyanate from the group consisting of polyisocyanates from the diphenylmethane series, polyisocyanate mixtures from the diphenylmethane series and reaction products thereof with at least one polyol component having a number-average molecular weight of 140 to 500 Da (measured according to DIN 53240; December 1971 and calculated by the formula: M=56 100⋅functionality/OH number) and a number-average functionality of 2 to 3, having NCO contents of 10% to 28% by weight NCO (called NCO prepolymers), or
   B2) at least one isocyanate from the group consisting of aliphatic polyisocyanates and reaction products thereof with at least one polyol component having a number-average molecular weight of 140 to 500 Da (measured according to DIN 53240; December 1971 and calculated by the formula: M=56 100⋅functionality/OH number) and a number-average functionality of 2 to 3, having NCO contents of 10% to 28% by weight NCO (called NCO prepolymers),
   wherein the index is 90 to 115, preferably 95 to 110, more preferably 97 to 108.

Particularly preferred inventive outer shells composed of polyurethane are those wherein the polyurethane is obtainable from:
A) a polyol component consisting of
   A1) 13% to 75% by weight of at least one polyether carbonate polyol (PEC) having a number-average molecular weight of 800 to 4500 Da (measured according to DIN 53240; December 1971 and calculated by the formula: M=56 100⋅functionality/OH number) and a number-average functionality of 2 to 3 and a proportion of incorporated CO₂ in the range from 14% to 25% by weight, based on the total mass of the PEC, and based on alkylene oxides from the group consisting of 70% to 100% by weight of propylene oxide and 0% to 30% by weight of ethylene oxide, and
   A2) 23% to 85% by weight of at least one further polyol having a number-average molecular weight of 200 to 6500 Da (measured according to DIN 53240; December 1971 and calculated by the formula: M=56 100⋅functionality/OH number) from the group consisting of 70% to 100% by weight of polyether polyols having a number-average functionality of 2 to 8, 0% to 30% by weight of polyester polyols having a number-average functionality of 2 to 3 and 0% to 30% by weight of polycarbonate polyols having a number-average functionality of 2 and
   A3) 2% to 20% by weight of aliphatic alkanediols having number-average molecular weights of 62 to 500 Da (measured according to DIN 53240; December 1971 and calculated by the formula: M=56 100⋅functionality/OH number) and
   A4) 0% to 10% by weight of short-chain aliphatic polyamines and/or aliphatic amino alcohols having number-average molecular weights of 60 to 1200 Da (measured according to DIN 53240; December 1971 and calculated by the formula: M=56 100⋅functionality/OH number or NH number) and a functionality of 2,
   A5) catalysts and
   A6) optionally auxiliaries and/or additives
   where the sum total of A1), A2), A3), A4), A5) and A6) is 100% by weight, and
B) an isocyanate component consisting of
   B1) at least one isocyanate from the group consisting of polyisocyanates from the diphenylmethane series, polyisocyanate mixtures from the diphenylmethane series and reaction products thereof with at least one polyol component having a number-average molecular weight of 140 to 500 Da (measured according to DIN 53240; December 1971 and calculated by the formula: M=56 100⋅functionality/OH number) and a number-average functionality of 2 to 3, having NCO contents of 10% to 28% by weight NCO, or

B2) at least one isocyanate from the group consisting of aliphatic polyisocyanates and reaction products thereof with at least one polyol component having a number-average molecular weight of 140 to 500 Da (measured according to DIN 53240; December 1971 and calculated by the formula: M=56 100⋅functionality/OH number) and a number-average functionality of 2 to 3, having NCO contents of 10% to 28% by weight NCO,

where the index is 90 to 115.

The molecular weight figures are number-average figures which have been measured according to DIN 53240; December 1971 and calculated by the formula: M=56100⋅functionality/OH or NH number (hydroxyl or amine number).

Polyether carbonate polyols (PECs) suitable as component A1), as described, for example, in WO 2008/092767 A1 or in EP 2 703 426 A1, are reaction products of alkylene oxides with CO₂ and low molecular weight starter polyols using what are called double metal cyanide catalysts, where the alkylene oxides have 2 to 8 carbon atoms and come from the group consisting of ethylene oxide, propylene oxide, butylene oxide, cyclohexane oxide and styrene oxide. Preference is given to propylene oxide and mixtures of ethylene oxide and propylene oxide where propylene oxide is in excess. The starter polyols have hydroxyl end groups and have molar masses of 100 to 1000 Da (measured according to DIN 53240; December 1971 and calculated by the formula: M=56 100⋅functionality/OH number (hydroxyl number)) and hydroxyl functionalities of 2 to 3. The proportion of incorporated CO₂ is preferably in the range from 12% to 30% by weight, more preferably from 14% to 25% by weight, based on the total mass of the PECs. The PECs have number-average molar masses of 600 to 6000 Da, preferably of 800 to 4500 Da.

Suitable polyether polyols in component A2) are compounds having at least two isocyanate-reactive hydroxyl groups. The number-average molecular weight of the polyether polyols used is 200 to 6500 Da. Preferably, the polyether polyols having OH groups are obtained by known processes, for example by anionic polymerization of epoxides, catalyzed by alkali metal hydroxides such as sodium or potassium hydroxide, or alkali metal alkoxides such as sodium methoxide, sodium or potassium ethoxide or potassium isopropoxide, with addition of at least one starter molecule incorporating 2 to 8, preferably 2 to 6, reactive hydrogen atoms, or by cationic polymerization of epoxides, catalyzed by Lewis acids such as antimony pentachloride, boron fluoride etherate inter alia or bleaching earth, with addition of at least one starter molecule incorporating 2 to 8, preferably 2 to 6, reactive hydrogen atoms. In addition, the polyether polyols can be prepared by means of double metal cyanide catalysis, with the possibility of a fully continuous mode of operation here too.

Examples of alkylene oxides suitable for preparation of polyether polyols of this kind include tetrahydrofuran, oxetane, 1,2- or 2,3-butylene oxide, ethylene oxide, 1,2-propylene oxide and styrene oxide. Particularly suitable alkylene oxides are those having 2 to 4 carbon atoms in the alkylene radical, especially ethylene oxide, 1,2-propylene oxide or 1,2-butylene oxide. The alkylene oxides may be metered in individually, in blockwise succession, in blockwise alternation, or as mixtures. Examples of useful starter molecules include aliphatic polyols, for example 1,3-propylene glycol, 1,2-propylene glycol, ethylene glycol, diethylene glycol, dipropylene glycol, butane-1,2-diol, butane-1,3-diol, butane-1,4-diol, hexanediol, pentanediol, 3-methylpentane-1,5-diol, dodecane-1,12-diol, water, glycerol, trimethylolpropane, triethanolamine, pentaerythritol, sorbitol, sucrose, hydroquinone, catechol, resorcinol, bisphenol F, bisphenol A, 1,3,5-trihydroxybenzene, methylol-containing condensates of formaldehyde and phenol, and Mannich bases. In addition, it is also possible to use ring-opening products of cyclic carboxylic anhydrides and polyols as starter compounds. Examples of these are ring-opening products formed from phthalic anhydride, succinic anhydride or maleic anhydride on the one hand, and ethylene glycol, diethylene glycol, butane-1,2-diol, butane-1,3-diol, butane-1,4-diol, hexanediol, pentanediol, 3-methylpentane-1,5-diol, dodecane-1,12-diol, glycerol, trimethylolpropane, pentaerythritol or sorbitol on the other hand. Ring-opening products of this kind can also be prepared in situ directly before the start of the alkylene oxide addition reaction in the polymerization reactor. In addition, it is also possible to use mono- or polyfunctional carboxylic acids directly as starter compounds. It is of course also possible to use mixtures of different starter compounds.

Suitable polyester polyols in component A2) are reaction products of at least bifunctional organic carboxylic acids and/or carboxylic acid equivalents with low molecular weight polyalcohols, where the polyester polyols have number-average molecular weights of 200 to 6500 Da, preferably 500 to 5000 Da, more preferably of 800 to 4500 Da, and functionalities of 2 to 3. Carboxylic acid equivalents here are at least bifunctional organic carboxylic esters based on low molecular weight alcohols, at least bifunctional organic carboxylic anhydrides and at least bifunctional organic internal esters, called lactones.

At least bifunctional organic carboxylic acids are, for example, glutaric acid, succinic acid, adipic acid, terephthalic acid, phthalic acid and isophthalic acid. Carboxylic esters with low molecular weight alcohols are especially understood to mean the methyl and ethyl esters. Carboxylic anhydrides are understood to mean internal anhydrides of the carboxylic acids, for example succinic anhydride, glutaric anhydride, maleic anhydride and phthalic anhydride. An internal ester is especially c-caprolactone. The aforementioned feedstocks can be used individually or in the form of mixtures.

Useful low molecular weight polyalcohols especially include ethylene glycol, diethylene glycol, propane-1,2-diol, propane-1,3-diol, butane-1,2-diol, butane-1,3-diol, butane-1,4-diol, pentane-1,5-diol, hexane-1,6-diol, 3-methylpentane-1,5-diol, 2-methylpropane-1,3-diol, dodecane-1,12-diol, glycerol, trimethylolpropane, and pentaerythritol.

It is of course possible for the abovementioned low molecular weight polyalcohols and the abovementioned carboxylic acids or carboxylic acid equivalents to be biobased, i.e. to have been produced from renewable raw materials by means of enzymatic and/or chemical processes. Examples include: succinic acid, adipic acid, propane-1,3-diol, butane-1,4-diol, ethylene glycol, diethylene glycol and glycerol.

The components mentioned can be converted in the presence of a catalyst. Alternatively, the conversion can be uncatalyzed.

Suitable polycarbonate polyols in component A2) are reaction products of at least bifunctional alcohols with carbonyl sources, where the polycarbonate polyols have number-average molecular weights of 200 to 6500 Da, preferably of 400 to 4000 Da, more preferably of 500 to 2000 Da, and functionalities of 2 to 3. Useful carbonyl sources especially include dimethyl carbonate, diethyl carbonate, diphenyl carbonate and phosgene. On the part of the alcohols, preference is given to using hexane-1,6-diol. It is also possible, for example, to use reaction products of hexane-1,6-diol with ϵ-caprolactone or reaction products of hexane-1,6-diol with adipic acid.

Particularly good results with regard to reduced water absorption are achieved when component A2) is selected such that it contains at least 50% by weight, preferably at least 70% by weight, more preferably at least 75% by weight, of polyether polyols, based on A2).

Aliphatic alkanediols suitable as component A3) have 2 to 12 carbon atoms. Particular preference is given to compounds from the group consisting of ethylene glycol, propane-1,3-diol, butane-1,4-diol, pentane-1,5-diol, hexane-1,6-diol, neopentyl glycol, octane-1,8-diol, nonane-1,9-diol, decane-1,10-diol and dodecane-1,12-diol.

Suitable short-chain aliphatic polyamines in component A4) have number-average molecular weights of 60 to 1200 Da. Examples include the products called the Jeffamines from Huntsman, and also isophoronediamine (IPDA) and diethyltolylenediamine (DETDA).

Suitable aliphatic amino alcohols in component A4) are, for example, ethanolamine, 1,2- and 1,3-propanolamine and butanolamine.

Suitable components A5) used may be the known catalysts for the urethane and urea reaction, as described in U.S. Pat. No. 4,218,543 or DE-A 39 14 718. Examples include tertiary amines or the tin(II) or tin(IV) salts of higher carboxylic acids and salts of bismuth.

Further auxiliaries and/or additives A6) used include stabilizers, such as the known polyether siloxanes, or separating agents, such as zinc stearate.

The known catalysts A5) and the auxiliaries and/or additives A6) are described, for example, in chapter 3.4 of the Kunststoffhandbuch [Plastics Handbook], Polyurethane [Polyurethanes], Carl Hanser Verlag (1993), p. 95 to 119, and can be used in the customary amounts.

Suitable polyisocyanates and polyisocyanate mixtures from the diphenylmethane series B1) are those polyisocyanates as formed in the phosgenation of aniline/formaldehyde condensates. The expression “polyisocyanate mixture from the diphenylmethane series” represents any desired mixtures of polyisocyanates from the diphenylmethane series, especially those mixtures obtained as distillation residue in the distillative separation of phosgenation products of aniline/formaldehyde condensates, and any desired blends with other polyisocyanates from the diphenylmethane series.

Typical examples of suitable polyisocyanates are 4,4′-diisocyanatodiphenylmethane, mixtures thereof with 2,2′- and especially 2,4′-diisocyanatodiphenylmethane, mixtures of these diisocyanatodiphenylmethane isomers with higher homologs thereof, as obtained in the phosgenation of aniline/formaldehyde condensates.

In addition, “polyisocyanates and polyisocyanate mixtures from the diphenylmethane series” also includes those isocyanates obtainable, for example, by partial carbodiimidization or allophanatization of the isocyanate groups in the di- and/or polyisocyanates mentioned, including mixtures of such modified di- and/or polyisocyanates with other di- and/or polyisocyanates from the diphenylmethane series.

Aliphatic polyisocyanates B2) used include cycloaliphatic and aliphatic polyisocyanates, preferably diisocyanates. Suitable diisocyanates are any desired diisocyanates that are obtainable by phosgenation or by phosgene-free methods, for example by thermal urethane cleavage, are from the molecular weight range of 140 to 400 and have aliphatically or cycloaliphatically bonded isocyanate groups, examples being 1,4-diisocyanatobutane, 1,6-diisocyanatohexane (HDI), 2-methyl-1,5-diisocyanatopentane, 1,5-diisocyanato-2,2-dimethylpentane, 2,2,4- or 2,4,4-trimethyl-1,6-diisocyanatohexane, 1,10-diisocyanatodecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 4,4′-diisocyanatodicyclohexylmethane, 1-isocyanato-l-methyl-4(3)isocyanatomethylcyclohexane, bis(isocyanatomethyl)norbornane or any desired mixtures of such diisocyanates. For production of the polyurethane outer shells of the invention, isophorone diisocyanate (IPDI) and hexamethylene diisocyanate (HDI) are particularly suitable. The isocyanates can be used in the form of the pure compound or in modified form, for example in the form of uretdiones, isocyanurates, allophanates, biurets, with iminooxadiazinedione and/or oxadiazinetrione structure, and/or carbodiimide-modified isocyanates. The diisocyanates preferably have an isocyanate content of 15% to 35% by weight.

The reaction products of B1) or B2) with at least one polyol component having a number-average molecular weight of 140 to 500 Da are understood to mean NCO prepolymers having NCO contents of 10% to 28% by weight. They can be obtained by reacting the respective component B1) or B2) with the polyol component in such ratios (NCO excess) as to result in NCO prepolymers having the NCO content mentioned. The reaction in this regard is generally effected within the temperature range from 25 to 100° C.

Suitable polyol components having number-average molecular weight from 140 to 500 Da are the alkoxylation products, known per se from polyurethane chemistry, of preferably di- or trifunctional starter molecules or mixtures of such starter molecules. Suitable starter molecules are, for example, water, ethylene glycol, diethylene glycol, propylene glycol, trimethylolpropane and glycerol. Alkylene oxides used for alkoxylation are especially propylene oxide and ethylene oxide, where these alkylene oxides can be used in any sequence and/or as a mixture.

The index (also called isocyanate index) is understood to mean the quotient of the molar amount [mol] of isocyanate groups actually used and the molar amount [mol] of isocyanate-reactive groups required in stoichiometric terms for the complete conversion of all isocyanate groups, multiplied by 100. Since one mole of an isocyanate group is required for the conversion of one mole of an isocyanate-reactive group, the following equation applies:

Index=(moles of isocyanate groups/moles of isocyanate-reactive groups)×100.

The production of the outer shell composed of polyurethane can be effected on the laboratory scale, for example, by admixing the polyol component A, preferably at room temperature, with the stoichiometric amount of isocyanate component B) relative to A, and vigorously mixing the mixture, for example by means of a Speedmixer, for 30 seconds. This mixture is then poured, for example, into a preheated mold that has optionally been treated with separating agent, the mold is closed and the outer shell is removed after the appropriate curing time.

The outer shell composed of polyurethane can alternatively be produced by the known reactive injection molding technique (RIM process), as described, for example, in DE-B 2 622 951 (U.S. Pat. No. 4,218,543) or DE-A 39 14 718.

Alternatively, the production of outer shells can also be effected by means of spraying or casting methods.

The polyurethanes for the outer shells of the invention have a water absorption at least 10% less than the water absorption of a corresponding polyurethane made from the same components except for component A1).

In the context of the present invention, the water absorption value is determined by producing planar PUR sheets, for example with dimensions of 20 cm×20 cm×0.38 cm, at room temperature and, one day after the production, cutting pieces of size 5 cm×5 cm×0.38 cm out of the sheets and removing any impurities, for example separating agent residues, from the test specimens. Subsequently, the mass of the dry test specimens is determined, then they are immersed completely in tap water (for example at 23° C.), for example for 7 days, and the mass of the test specimens is determined again after this period of time. The difference in mass is expressed in percent based on the starting value.

The invention is to be elucidated in detail by the examples which follow.

### EXAMPLES SECTION

### A) Methods and Equipment

Hydroxyl numbers (OHN) were determined according to DIN 53240; December 1971.

Acid numbers were determined according to DIN EN ISO 2114 (June 2002).

Viscosities were determined at the temperature specified in each case according to EN ISO 3219 in the October 1994 version.

The proportion of CO₂ incorporated in the resulting polyether carbonate polyol (“CO₂ incorporated”) and the ratio of propylene carbonate to polyether carbonate polyol were determined by ¹H NMR (Bruker DPX 400, 400 MHz; pulse program zg30, relaxation delay d1: 10 s, 64 scans). Each sample was dissolved in deuterated chloroform. The relevant resonances in the ¹H NMR (based on TMS=0 ppm) are as follows:

Cyclic carbonate (which was formed as a by-product) resonance at 4.5 ppm, carbonate resulting from carbon dioxide incorporated in the polyether carbonate polyol (resonances at 5.1 to 4.8 ppm), unreacted propylene oxide (PO) with resonance at 2.4 ppm, polyether polyol (i.e. without incorporated carbon dioxide) with resonances at 1.2 to 1.0 ppm.

The molar proportion of the carbonate incorporated in the polymer, of the polyether polyol and of the unreacted PO (propylene oxide) are determined by integration of the corresponding signals.

Further details are given in detail in WO 2014/033 071.

B) Commercially Available Starting Materials:

Isopur® Schwarzpaste N black paste from ISL-Chemie GmbH+Co. KG.

Irganox® 1135: alkyl 3,5-bis(isobutyl)-4-hydroxybenzene- 1-propionate, antioxidant from BASF.

Tinuvin® B75: light-stabilizing additive from BASF

Fomrez® UL28: dimethylbis[(1-oxoneodecyl)oxy]stannane; catalyst from Chemtura Vinyl

Additives GmbH

Dabco 33LV: 33% by weight of triethylenediamine in dipropylene glycol, catalyst from Air Products

Desmorapid® VP.PU 20AK36: tin catalyst from Bayer MaterialScience

Desmophen® 4050E: amine-based tetrafunctional polyether polyol from Bayer MaterialScience with a hydroxyl number of about 625 mg KOH/g and a viscosity at 25° C. of about 19 000 mPa⋅s

Desmophen® L2830: bifunctional polyether polyol with predominantly primary hydroxyl groups from Bayer MaterialScience with a hydroxyl number of 26-30 mg KOH/g and a viscosity at 25° C. of 790-930 mPa⋅s

PET 5168T: bifunctional polyether polyol with predominantly primary hydroxyl groups from Bayer MaterialScience with a hydroxyl number of about 28 mg KOH/g and a viscosity at 25° C. of about 1000 mPa⋅s

Polyether V2725: trifunctional polyether polyol with predominantly primary hydroxyl groups from Bayer MaterialScience with a hydroxyl number of about 28 mg KOH/g and a viscosity at 25° C. of about 1500 mPa⋅s

Desmophen® 4011T: trifunctional polyether polyol from Bayer MaterialScience with a hydroxyl number of 525-575 mg KOH/g and a viscosity at 25° C. of about 1540-2060 mPa⋅s

Polyether L800: bifunctional polyether polyol from Bayer MaterialScience with a hydroxyl number of about 515 mg KOH/g and a viscosity at 25° C. of about 80 mPa⋅s

PET 3973Y: trifunctional polyether polyol with predominantly primary hydroxyl groups from Bayer MaterialScience with a hydroxyl number of about 28 mg KOH/g and a viscosity at 25° C. of about 1100 mPa⋅s

Desmophen® C XP 2716: linear aliphatic polycarbonatediol having terminal hydroxyl groups from Bayer MaterialScience with a molecular weight of about 650 g/mol and a viscosity at 25° C. of about 4100 mPa⋅s

Desmodur® E 305: aliphatic polyisocyanate having terminal NCO groups from Bayer MaterialScience with a molecular weight of about 650 g/mol and a viscosity at 25° C. of about 4000 mPa⋅s

Desmodur® PA 09: modified diphenylmethane 4,4′-diisocyanate from Bayer MaterialScience with an NCO content of 24.0%-25.0% by weight and a viscosity at 25° C. of 375-575 mPa⋅s

Desmodur® 481F44: aliphatic polyisocyanate from Bayer MaterialScience with an NCO content of about 21% and a viscosity at 20° C. of about 9015 mPa⋅s

Desmodur® XP2489: aliphatic polyisocyanate from Bayer MaterialScience with an NCO content of about 21.0±0.5% and a viscosity at 23° C. of about 22 500±2500 mPa⋅s

Arcol® Polyol 1004: PET 1004: bifunctional polyether polyol from Bayer MaterialScience for preparation of polyurethanes with a hydroxyl number of about 260 mg KOH/g and a viscosity at 25° C. of about 220 mPa⋅s

Butane-1,4-diol: from Acros

Ethylene glycol: from Acros

Diethylene glycol: Sigma Aldrich

Propylene carbonate (cPC): from Acros

Indrosil® 2000: separating agent from Indroma Chemikalien

IPDA: isophoronediamine from Evonik

DMC catalyst: was prepared as described in example 6 of WO 01/80994 A1

### C) Preparation of Polyester Polyols, PES-C

### Preparation of the Polyester Polyol 1 (PES C-1):

In a 2 liter four-neck flask (equipped with mechanical stirrer, 50 cm Vigreux column, thermometer, nitrogen inlet, column head, distillation system and vacuum membrane pump), 602 g of adipic acid (4.122 mol, corresponding to 52.45% by weight) and 546 g (5.147 mol, corresponding to 47.55% by weight) of diethylene glycol were heated to 200° C. under a nitrogen blanket over the course of 60 min, in the course of which water of reaction was removed by distillation. After 3 hours, 20 mg of zinc dichloride dihydrate (corresponding to 20 ppm based on the end product) were added and the reaction was continued. After a total reaction time of 5 hours, the pressure was reduced gradually to 15 mbar over the course of 1 hour. Over the course of further reaction, the acid number was monitored. After a total reaction time of 33 hours, the reaction was ended. The acid number was 0.42 mg KOH/g.

### Analysis of the Polyester:

Hydroxyl number: 112.2 mg KOH/g

Acid number: 0.42 mg KOH/g

Viscosity: 170 mPas (75° C.)

### Preparation of the Polyester Polyol 2 (PES C-2) :

In a 2 liter four-neck flask (equipped with mechanical stirrer, 50 cm Vigreux column, thermometer, nitrogen inlet, column head, distillation system and vacuum membrane pump), 638 g of adipic acid (4.366 mol, corresponding to 55.14% by weight) and 519 g (4.892 mol, corresponding to 44.86% by weight) of diethylene glycol were heated to 200° C. under a nitrogen blanket over the course of 60 min, in the course of which water of reaction was removed by distillation. After 3 hours, 20 mg of zinc dichloride dihydrate (corresponding to 20 ppm based on the end product) were added and the reaction was continued. After a total reaction time of 5 hours, the pressure was reduced gradually to 15 mbar over the course of 1 hour. Over the course of further reaction, the acid number was monitored. After a total reaction time of 35 hours, the reaction was ended. The acid number was 0.37 mg KOH/g.

### Analysis of the Polyester:

Hydroxyl number: 56.7 mg KOH/g

Acid number: 0.37 mg KOH/g

Viscosity: 540 mPas (75° C.)

Preparation of the polyester polyol 3 (PES C-3) :

In a 2 liter four-neck flask (equipped with mechanical stirrer, 50 cm Vigreux column, thermometer, nitrogen inlet, column head, distillation system and vacuum membrane pump), 657 g of adipic acid (4.498 mol, corresponding to 56.57% by weight) and 505 g (4.756 mol, corresponding to 43.43% by weight) of diethylene glycol were heated to 200° C. under a nitrogen blanket over the course of 60 min, in the course of which water of reaction was removed by distillation. After 3 hours, 20 mg of zinc dichloride dihydrate (corresponding to 20 ppm based on the end product) were added and the reaction was continued. After a total reaction time of 5 hours, the pressure was reduced gradually to 15 mbar over the course of 1 hour. Over the course of further reaction, the acid number was monitored. After a total reaction time of 40 hours, the reaction was ended. The acid number was 0.67 mg KOH/g.

### Analysis of the Polyester:

Hydroxyl number: 26.6 mg KOH/g

Acid number: 0.67 mg KOH/g

Viscosity: 2930 mPas (75° C.)

TABLE 1
Overview of polyester polyols PES C-1 to C-3

| Example | | PES C-1 | PES C-2 | PES C-3 |
|---|---|---|---|---|
| Formation: | | | | |
| Adipic acid | [% by wt.] | 52.45 | 55.14 | 56.57 |
| Diethylene glycol | [% by wt.] | 47.55 | 44.86 | 43.43 |
| Analysis: | | | | |
| Hydroxyl number | [mg KOH/g] | 112.2 | 56.7 | 26.6 |
| Acid number | [mg KOH/g] | 0.42 | 0.37 | 0.67 |
| Viscosity | [mPas, 75° C.] | 170 | 540 | 2930 |

### D) Preparation of the Polyether Carbonate Polyols, PEC-D

### Preparation of Polyether Carbonate Polyol 1 (PEC D-1)

A nitrogen-purged 60 L pressure reactor with a gas metering unit (gas inlet tube) was initially charged with a suspension of 15.14 g of DMC catalyst (prepared as per example 6 of WO 01/80994 A1) and 4700 g of cyclic propylene carbonate (cPC). The reactor was heated to about 100° C. and inertized with N₂ at a pressure g_{abs}=100 mbar for 1 h. The reactor was then adjusted to a pressure of 74 bar with CO₂. 500 g of propylene oxide (PO) were metered into the reactor at 110° C. while stirring (316 rpm) within 2 min. The onset of the reaction was signaled by a temperature spike (“hotspot”) and a pressure drop. On completion of activation, 34.43 kg of propylene oxide at 8.2 kg/h and 3.25 kg of monopropylene glycol at 0.79 kg/h were metered simultaneously into the reactor. In the course of this, the reaction temperature was lowered to 105° C. and the pressure was kept constant by metering in further CO₂. After the metered addition had ended, stirring was continued for 30 min. The cyclic propylene carbonate was separated from the polyether carbonate polyol in a thin-film evaporator (T=140° C., p_{abs}<3 mbar, 400 rpm).

Table 2 below states the analytical data for the resulting polyether carbonate polyol (content of incorporated CO₂, hydroxyl number (OHN) and viscosity).

### Preparation of Polyether Carbonate Polyol 2 (PEC D-2)

A nitrogen-purged 60 L pressure reactor with a gas metering unit (gas inlet tube) was initially charged with a suspension of 9.97 g of DMC catalyst (prepared as per example 6 of WO 01/80994 A1) and 4700 g of PET 1004. The reactor was heated to about 100° C. and inertized with N₂ at a pressure g_{abs} =100 mbar for 1 h. 963 g of propylene oxide (PO) were metered into the reactor at 125° C. while stirring (316 rpm) within 2 min. The onset of the reaction was signaled by a temperature spike (“hotspot”) and a pressure drop. This operation was then repeated under 54 bar of CO₂, in the course of which 585 g of propylene oxide were metered in. After the activations, 33.62 kg of propylene oxide were metered in at 7.0 kg/h. In the course of this, the reaction temperature was lowered to 105° C. and the pressure was kept constant by metering in further CO₂. After the metered addition had ended, stirring was continued for 30 min. The cyclic propylene carbonate was separated from the polyether carbonate polyol in a thin-film evaporator (T =140° C., p_{abs}<3 mbar, 400 rpm).

Table 2 below states the analytical data for the resulting polyether carbonate polyol (content of incorporated CO₂, hydroxyl number (OHN) and viscosity).

### Preparation of Polyether Carbonate Polyol 3 (PEC D-3)

A nitrogen-purged 60 L pressure reactor with a gas metering unit (gas inlet tube) was initially charged with a suspension of 14.25 g of DMC catalyst (prepared as per example 6 of WO 01/80994 A1) and 4700 g of cyclic propylene carbonate (cPC). The reactor was heated to about 100° C. and inertized with N₂ at a pressure p_{abs}=100 mbar for 1 h. The reactor was then adjusted to a pressure of 74 bar with CO₂. 500 g of propylene oxide (PO) were metered into the reactor at 110° C. while stirring (316 rpm) within 2 min. The onset of the reaction was signaled by a temperature spike (“hotspot”) and a pressure drop. On completion of activation, 31.898 kg of propylene oxide at 7.6 kg/h and 1.5 kg of monopropylene glycol at 0.4 kg/h were metered simultaneously into the reactor. In the course of this, the reaction temperature was lowered to 107° C. and the pressure was kept constant by metering in further CO₂. After the metered addition had ended, stirring was continued for 30 min. The cyclic propylene carbonate was separated from the polyether carbonate polyol in a thin-film evaporator (T=140° C., p_{abs}<3 mbar, 400 rpm).

Table 2 below states the analytical data for the resulting polyether carbonate polyol (content of incorporated CO₂, hydroxyl number (OHN) and viscosity).

TABLE 2
Overview of polyether carbonate polyols, PEC D-1 to PEC D-3

| | CO₂ content | Hydroxyl number |
|---|---|---|
| Example | [% by wt.] | [mg KOH/g] |
| PEC D-1 | 15.2 | 118.4 |
| PEC D-2 | 19.6 | 27.7 |
| PEC D-3 | 18.22 | 55.5 |

E.) Production of Slabs with the Aid of a Speedmixer:

The polyol component was initially charged at room temperature (23-27° C.) in a closable 500 mL PE beaker, and the specified amount of isocyanate component was added, the isocyanate component having been equilibrated to room temperature in the examples adduced in table 1 and in example 5-V, and having been preheated to 50° C. in the other examples. After closure of the vessel, the vessel was inserted into the dedicated holder in the Speedmixer, and the two components were mixed vigorously for 30 seconds. The mixture was transferred into an aluminum mold of size 20×20×0.38 cm with a lid, which had been preheated to 80° C. and treated with Indrosil 2000 separating agent.

The slabs from the examples adduced in table 3 and in the case of example 5-V were demolded after 1 minute, the others after 2 minutes. The density of the moldings for all slabs was 1.1+/−0.1 g/cm³.

### F.) Preparation of the Storage Samples:

One day after the production, pieces of size 5×5 cm were sawn out of the slabs. Ethanol and a paper tissue were used to remove any residues of separating agent from the test samples. The dry specimens were weighed accurately, then immersed completely in tap water and then removed from the water and weighed again according to the storage cycles specified. The difference in weight was reported in percent in each case.

The analyses were conducted as follows:

Water absorption was determined by gravimetric means. For this purpose, the slabs were weighed at room temperature, then stored in water for 7 days and then, after dabbing off residual water, weighed again. The values for water absorption were reported as a percentage based on the starting value.

TABLE 3
Formulations and properties of inventive and noninventive
polyurethanes compared to an aromatic standard system,
comparative example 1-V.

| Example: | | 1-V* | 2 | 3-V* | 4-V* |
|---|---|---|---|---|---|
| Desmophen ® L2830 | [pts. by wt.] | 6.00 | | | |
| PET 5168T | [pts. by wt.] | 12.00 | | | |
| Polyether V2725 | [pts. by wt.] | 55.70 | 55.70 | 55.70 | 55.70 |
| PES C-2 | [pts. by wt.] | | | | 18.00 |
| PES C-3 | [pts. by wt.] | | | 18.00 | |
| PEC D-3 | [pts. by wt.] | | 18.00 | | |
| Ethylene glycol | [pts. by wt.] | 15.00 | 15.00 | 15.00 | 15.00 |
| Desmophen ® 4050E | [pts. by wt.] | 3.00 | 3.00 | 3.00 | 3.00 |
| Isopur ® | [pts. by wt.] | 6.20 | 6.20 | 6.20 | 6.20 |
| Schwarzpaste N | | | | | |
| Tinuvin ® B75 | [pts. by wt.] | 1.50 | 1.50 | 1.50 | 1.50 |
| Fomrez ® UL28 | [pts. by wt.] | 0.30 | 0.30 | 0.30 | 0.30 |
| Dabco 33LV | [pts. by wt.] | 0.30 | 0.30 | 0.30 | 0.30 |
| Sum total of polyol side | [pts. by wt.] | 100.0 | 100.0 | 100.0 | 100.0 |
| Polyisocyanate side: | | | | | |
| Desmodur ® PA09 | [pts. by wt.] | 96.13 | 97.67 | 96.05 | 97.70 |
| Index | | 100.0 | 100.0 | 100.0 | 100.0 |
| Water absorption after | | 1.63 | 1.28 | 1.53 | 1.7 |
| 7 days [% by wt.] | | | | | |

*V = comparison

Comparative example 1-V is an aromatic system. The water absorption here is 1.63% by weight. In inventive example 2, the bifunctional long-chain polyether polyols Desmophen® L 2830 and PET 5168T were exchanged for the polyether carbonate polyol PEC D-3. This change in formulation significantly reduced the water absorption value.

An analogous exchange of the bifunctional long-chain polyether polyols Desmophen® L 2830 and PET 5168T for the polyester polyols PES C-2 and PES C-3, by contrast, gives only a small improvement (comparative example 3-V) and, in comparative example 4-V, actually a slight deterioration in the water absorption values.

TABLE 4
Formulations and properties of inventive and noninventive
polyurethanes compared to an aliphatic standard system,
comparative example 5-V.

| | | Example: | | | | |
|---|---|---|---|---|---|---|
| | | 5-V* | 6 | 7 | 8-V* | 9-V* |
| PET 5168T | [pts. | 65.00 | | | | |
| | by | | | | | |
| | wt.] | | | | | |
| PES C-2 | [pts. | | | | | 65.00 |
| | by | | | | | |
| | wt.] | | | | | |
| PES C-3 | [pts. | | | | 65.00 | |
| | by | | | | | |
| | wt.] | | | | | |
| PEC D-2 | [pts. | | 65.00 | | | |
| | by | | | | | |
| | wt.] | | | | | |
| PEC D-3 | [pts. | | | 65.00 | | |
| | by | | | | | |
| | wt.] | | | | | |
| Butane-1,4-diol | [pts. | 5.00 | 5.00 | 5.00 | 5.00 | 5.00 |
| | by | | | | | |
| | wt.] | | | | | |
| Polyether L800 | [pts. | 10.00 | 10.00 | 10.00 | 10.00 | 10.00 |
| | by | | | | | |
| | wt.] | | | | | |
| Desmophen ® | [pts. | 15.00 | 15.00 | 15.00 | 15.00 | 15.00 |
| 4011T | by | | | | | |
| | wt.] | | | | | |
| Isopur ® | [pts. | 5.00 | 5.00 | 5.00 | 5.00 | 5.00 |
| Schwarzpaste N | by | | | | | |
| | wt.] | | | | | |
| Tinuvin ® B75 | [pts. | 0.75 | 0.75 | 0.75 | 0.75 | 0.75 |
| | by | | | | | |
| | wt.] | | | | | |
| Fomrez ® UL28 | [pts. | 1.00 | 1.00 | 1.00 | 1.00 | 1.00 |
| | by | | | | | |
| | wt.] | | | | | |
| Sum total of polyol | [pts. | 101.75 | 101.75 | 101.75 | 101.75 | 101.75 |
| side | by | | | | | |
| | wt.] | | | | | |
| Polyisocyanate side: | | | | | | |
| Desmodur ® | [pts. | 79.64 | 79.64 | 86.35 | 79.31 | 86.52 |
| 48IF44 | by | | | | | |
| | wt.] | | | | | |
| Index | | 100.0 | 100.0 | 100.0 | 100.0 | 100.0 |
| Water absorption | | 2.61 | 1.8 | 0.9 | 2.35 | 2.17 |
| after 7 days | | | | | | |
| [% by wt.] | | | | | | |

*V = comparison

Comparative example 5-V is an aliphatic system having a water absorption value of 2.61% by weight.

In the case of inventive examples 6 and 7, the bifunctional long-chain polyether polyol PET 5168T was exchanged for the polyether carbonate polyols PEC D-2 and PEC D-3 respectively. As a result, there was a significant decrease in water absorption from 2.61% by weight (comparative example 5-V—standard) to 1.8% by weight (inventive example 6) or 0.9% by weight (inventive example 7).

An analogous exchange for the polyester polyols PES C-2 and PES C-3, by contrast, gives only a small improvement in water absorption (comparative examples 8-V and 9-V).

TABLE 5
Formulations and properties of inventive and noninventive polyurethanes
compared to an aliphatic, polycarbonatediol-containing standard system,
comparative example 10-V.

| Example: | | 10-V* | 11 | 12-V* |
|---|---|---|---|---|
| PET 3973Y | [pts. by wt.] | 59.52 | 59.52 | 59.52 |
| PES C-1 | [pts. by wt.] | | | 17.67 |
| PEC D-1 | [pts. by wt.] | | 17.67 | |
| Butane-1,4-diol | [pts. by wt.] | 8.84 | 8.84 | 8.84 |
| Desmophen ® C XP 2716 | [pts. by wt.] | 17.67 | | |
| Desmophen ® 4011T | [pts. by wt.] | 8.84 | 8.84 | 8.84 |
| IPDA | [pts. by wt.] | 2.94 | 2.94 | 2.94 |
| Isopur ® Schwarzpaste N | [pts. by wt.] | 5.00 | 5.00 | 5.00 |
| Tinuvin ® B75 | [pts. by wt.] | 0.75 | 0.75 | 0.75 |
| Irganox ® 1135 | [pts. by wt.] | 1.00 | 1.00 | 1.00 |
| Fomrez ® UL28 | [pts. by wt.] | 0.44 | 0.44 | 0.44 |
| Dabco 33LV | [pts. by wt.] | | | |
| Sum total of polyol side | [pts. by wt.] | 105.0 | 105.0 | 105.0 |
| Polyisocyanate side: | | | | |
| Desmodur ® XP2489 | [pts. by wt.] | 52.74 | 50.24 | 50.25 |
| Desmodur ® E 305 | [pts. by wt.] | 52.74 | 50.24 | 50.25 |
| Index | | 105.0 | 105.0 | 105.0 |
| Water absorption after 7 days | | 3.87 | 3.39 | 3.77 |
| [% by wt.] | | | | |

*V = comparison

Noninventive example 10-V is an aliphatic, polycarbonatediol-containing (Desmophen® C XP 2716) system.

In inventive example 11, the bifunctional aliphatic polycarbonatediol Desmophen® C XP 2716 was exchanged for the polyether carbonate polyol PEC D-1. As a result, there was a significant decrease in the water absorption value from 3.87% by weight to 3.39% by weight.

In noninventive example 12-V, the bifunctional aliphatic polycarbonatediol Desmophen® C XP 2716 was exchanged for the polyester polyol PES C-1. The water absorption value decreased only slightly from 3.87% by weight to 3.77% by weight.

The results from tables 3 to 5 show unambiguously that optimal results in terms of minimum water absorption values are achieved when PEC polyols are used in place of polyether polyols, polyester polyols or polycarbonate polyols.

A high PEC content (inventive examples 6 and 7) tends to bring about a more significant reduction in water absorption than a low content (inventive example 2).

1. An outer shell composed of polyurethane, wherein the polyurethane is obtained from:
A) a polyol component consisting of:
A1) 5% to 90% by weight of at least one polyether carbonate polyol (PEC) having a number-average molecular weight (M) of 600 to 6000 Da and a number-average functionality of 2 to 3;
A2) 10% to 95% by weight of at least one further polyol having a number-average molecular weight of 200 to 6500 Da selected from the group consisting of polyether polyols having a number-average functionality of 2 to 8, polyester polyols having a number-average functionality of 2 to 3, and polycarbonate polyols having a number-average functionality of 2 to 3;
A3) 2% to 20% by weight of aliphatic alkanediols having number-average molecular weights of 62 to 500 Da;
A4) 0% to 10% by weight of short-chain aliphatic polyamines and/or aliphatic amino alcohols having number-average molecular weights of 60 to 1200 Da and a functionality of 2;
A5) catalysts; and
A6) optionally auxiliaries and/or additives;
where the sum total of A1), A2), A3), A4), A5) and A6) is 100% by weight of component A); and
B) an isocyanate component consisting of:
B1) at least one isocyanate selected from the group consisting of polyisocyanates from the diphenylmethane series, polyisocyanate mixtures from the diphenylmethane series, and reaction products thereof with at least one polyol component having a number-average molecular weight of 140 to 500 Da and a number-average functionality of 2 to 3, having NCO contents of 10% to 28% by weight NCO; or
B2) at least one isocyanate selected from the group consisting of aliphatic polyisocyanates and reaction products thereof with at least one polyol component having a number-average molecular weight of 140 to 500 Da and a number-average functionality of 2 to 3, having NCO contents of 10% to 28% by weight NCO; wherein the index is 90 to 115.

2. The outer shell composed of polyurethane as claimed in claim 1, wherein the polyurethane is obtained from:
A) a polyol component consisting of:
A1) 13% to 75% by weight of at least one polyether carbonate polyol (PEC) having a number-average molecular weight of 800 to 4500 Da and a number-average functionality of 2 to 3 and a proportion of incorporated CO₂ in the range from 14% to 25% by weight, based on the total mass of the PEC, and based on alkylene oxides selected from the group consisting of 70% to 100% by weight of propylene oxide and 0% to 30% by weight of ethylene oxide;
A2) 23% to 85% by weight of at least one further polyol having a number-average molecular weight of 200 to 6500 Da selected from the group consisting of 70% to 100% by weight of polyether polyols having a number-average functionality of 2 to 8, 0% to 30% by weight of polyester polyols having a number-average functionality of 2 to 3, and 0% to 30% by weight of polycarbonate polyols having a number-average functionality of 2;
A3) 2% to 20% by weight of alkanediols having number-average molecular weights of 62 to 500 Da;
A4) 0% to 10% by weight of short-chain aliphatic polyamines and/or aliphatic amino alcohols having number-average molecular weights of 60 to 1200 Da and a functionality of 2;
A5) catalysts; and
A6) optionally auxiliaries and/or additives;
where the sum total of A1), A2), A3), A4), A5) and A6) is 100% by weight of component A); and
B) an isocyanate component consisting of:
B1) at least one isocyanate selected from the group consisting of polyisocyanates from the diphenylmethane series, polyisocyanate mixtures from the diphenylmethane series, and reaction products thereof with at least one polyol component having a number-average molecular weight of 140 to 500 Da and a number-average functionality of 2 to 3, having NCO contents of 10% to 28% by weight NCO; or
B2) at least one isocyanate selected from the group consisting of aliphatic polyisocyanates and reaction products thereof with at least one polyol component having a number-average molecular weight of 140 to 500 Da and a number-average functionality of 2 to 3, having NCO contents of 10% to 28% by weight NCO;
wherein the index is 90 to 115.

3. An outer shell for encasing sheets, slabs, tiles, laminates, wooden boards, metal plates and cables comprising the outer shell as claimed in claim 1

4. An outer shell for encasing sheets, slabs, tiles, laminates, wooden boards, metal plates and cables comprising the outer shell as claimed in claim 2.
